(19) United States
(12) Patent Application Publication
(10) Pub. No.: US 2011/0041939 A1
(43) Pub. Date: Feb. 24, 2011

(54) Shut Off and Test Valve

(75) Inventor: Bernardo Tedeschi, Reggio Emilia (IT)

Correspondence Address: FISH & RICHARDSON P.C. (DA), P.O. BOX 1022, MINNEAPOLIS, MN, 55440-1022, US

(73) Assignee: Fimcim S.p.A.

(21) Appl. No.: 12/861,332

(22) Filed: Aug. 23, 2010

(30) Foreign Application Priority Data
Aug. 24, 2009 (IT) MI2009A001499

(51) Int. Cl. F16K 11/056

(52) U.S. Cl. 137/625.41

(57) ABSTRACT

A shut-off and test valve (1, 101) for gas plants comprising a valve base body (2, 102) having an inlet (4, 104), an outlet (3, 103) and a further inlet (20, 120), a hollow spherical shutter (11, 111) provided with a first opening (16, 116), a second opening (17, 117) and a third opening (12, 112); the valve being exclusively configurable between an activating condition, a test condition and a security condition in which the shutter (11, 111) is positioned such as to prevent any fluid communication between the inlet (4, 104), the outlet (3, 103) and a further inlet (20, 120) of the valve body (1, 102).

### REFERENCE TO RELATED APPLICATIONS

The present application claims priority under 35 U.S.C. §119 to Italian Patent Application No. MI2009A001499, filed Aug. 24, 2009, the entirety of which is hereby incorporated by reference.

### BACKGROUND

Testing a gas dispensing plant is carried out by placing a test gas in the plant in order to verify that there are no leaks and that the plant is capable of functioning at operating pressures established in its design.

A test valve is generally mounted at the position of the plant's counter and beyond functioning as a normal plant check valve, i.e. destined to enable or disenable gas flow in the plant, it is provided with a supplementary inlet through which a test gas can be introduced into the plant during the testing operations.

Known valves in the prior art exhibit various defects.

Firstly if the test gas inlet opening is accidentally left open after testing operations, known valves are not able to prevent a gas leak through the opening during normal functioning of the plant, with the risk of explosion and leakage of the gas into the environments where the plant is installed.

Further, during the testing stage, if by mistake a test gas is injected into the plant at an excessive pressure, there is the risk of damage to the plant counter; in other words, the known valves are not able to prevent the test gas from being injected by mistake into the counter associated to the plant, with the risk of damaging the counter and injecting the test gas into the supply network connected to the counter, thus mixing it with the combustible gas of the supply network.

Patent JP11304013 describes a shut-off and test valve for gas plants which includes a valve body comprising, beyond the normal inlet and outlet for the gas, also an inspection access for plant control.

The valve of the document is however configurable in a plurality of positions which enable among other things placing the test access in communication with the network upstream of the user, i.e. with the counter.

The above reiterates all the safety problems described herein above, as the functioning mode increases the risks of damage to the plant in a case of erroneous use of the valve.

### SUMMARY

The present disclosure relates to a shut-off and test valve for gas plants, in particular a valve for enabling testing of a combustible gas dispensing plant, for example methane.

In certain instances, the concepts described herein provide a shut-off and test valve for a gas dispensing plant internally of a building which obviates the above-indicated drawbacks.

The shut-off and test valve for gas dispensing plants comprises the technical characteristics set out in the claims.

In certain instances, during normal functioning of the plant and during plant testing operations, it is guaranteed that accidental leakage of gas through the valve cannot occur.

In certain instances, it is further guaranteed that damage cannot occur to the counter associated to the plant if, during the stage of testing the plant, a test gas is introduced into the plant at an excessive pressure.

Finally, in certain instances, it is guaranteed that during the testing operations of the plant the test gas cannot be introduced into the gas supply piping.

The details of one or more embodiments are set forth in the accompanying drawings and the description below. Other features, objects, and advantages will be apparent from the description and drawings, and from the claims.

### DESCRIPTION OF DRAWINGS

FIG. 1 is a perspective view of a first actuation of a valve in accordance with the concepts described herein;

FIG. 1A is an exploded perspective view of the valve of FIG. 1;

FIG. 2 is a view from above of the valve of FIG. 1;

FIG. 3 is an elevation of the valve of FIG. 1;

FIG. 4 is a view from the left of FIG. 3;

FIG. 5 is section V-V of FIG. 2;

FIG. 6 is section VI-VI of FIG. 3;

FIG. 7 is section VII-VII of FIG. 4;

FIGS. 8 to 10 are sections as in FIG. 7 which illustrate a first, second and third operating position, respectively, of the valve of FIG. 1;

FIG. 11 is a larger-scale detail of FIG. 10;

FIG. 12 is a perspective view of a second embodiment of a valve in accordance with the concepts described herein;

FIG. 12A is an exploded perspective view of the valve of FIG. 12;

FIG. 13 is a view from above of the valve of FIG. 12;

FIG. 14 is a view in elevation of the valve of FIG. 12;

FIG. 15 is a view from the left of FIG. 14;

FIG. 16 is section XVI-XVI of FIG. 13;

FIG. 17 is section XVII-XVII of FIG. 14;

FIG. 18 is section XVIII-XVIII of FIG. 15;

FIGS. 19 to 21 are sections as in FIG. 16 which illustrate a first, second and third operating position, respectively, of the valve of FIG. 12;

FIG. 22 is a larger-scale detail of FIG. 21;

FIGS. 23 and 24 are a perspective view of a third embodiment of a valve in accordance with the concepts described herein;

FIG. 25 is an exploded perspective view of the valve of FIG. 23;

FIGS. 26, 27 and 28 are corresponding lateral views of the valve of FIG. 23 in an open, closed and partially closed condition; and

FIGS. 26A, 27A and 28A are corresponding section views according to axes C-C, D-D and E-E of the valve of FIGS. 26, 27 and 28 in the open, closed and partially closed positions.

### DETAILED DESCRIPTION

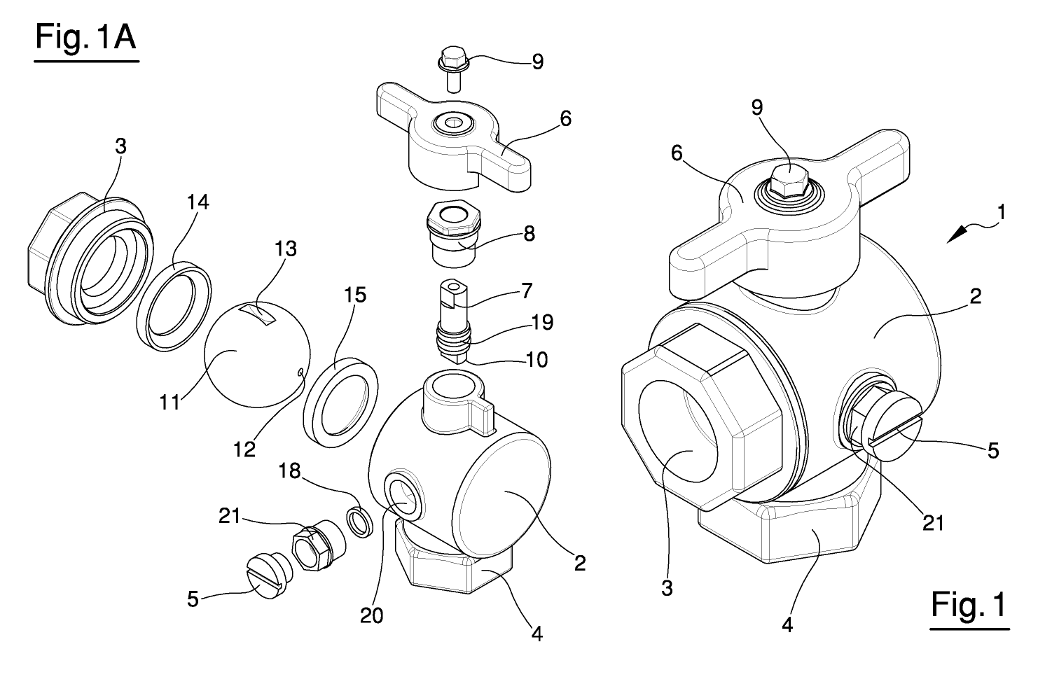

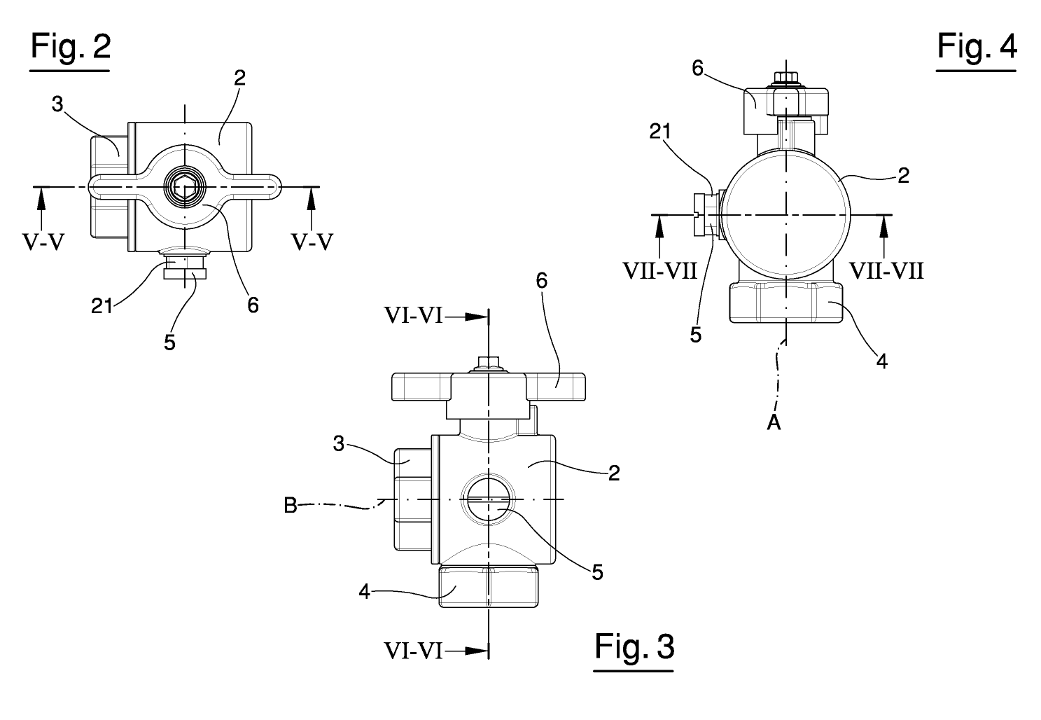

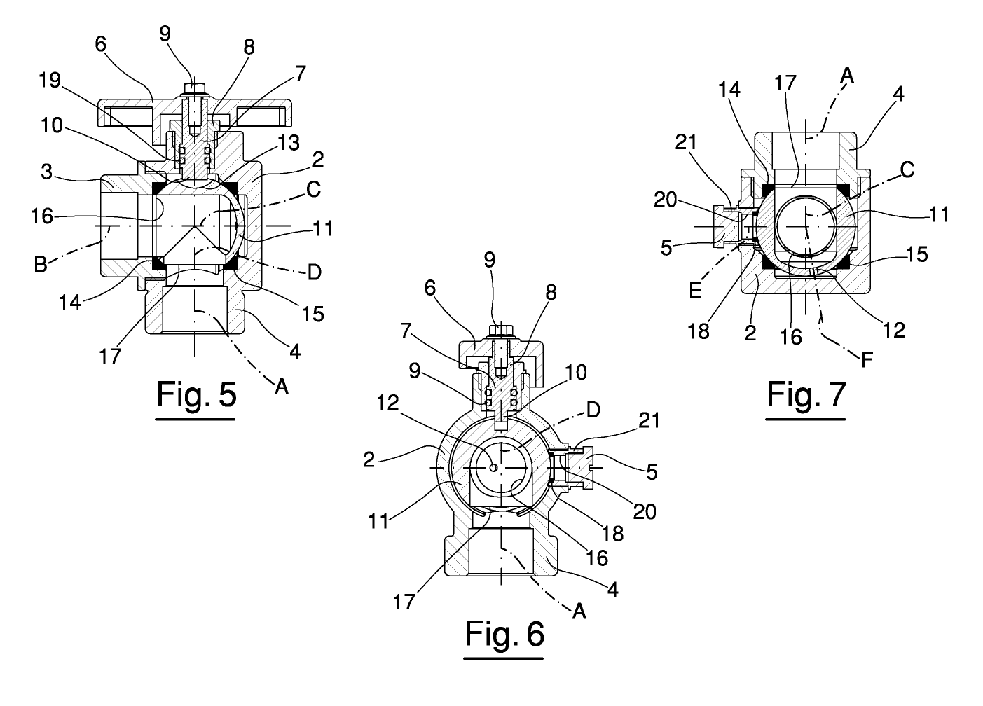

FIGS. 1 to 11 illustrate a first version of a valve 1 in accordance with the concepts described herein, which comprises a hollow valve body 2 provided with an inlet 4 destined to be connected with a combustible gas supply network, for example methane, and an outlet 3 destined to be connected to a dispensing plant of the combustible gas in a building. In the first version, the inlet 4 and the outlet 3 have respective axes A and B which are substantially perpendicular to one another.

The valve body 2 is further provided with a further inlet 20 that can be used to inject a pressurized test gas into the dispensing plant in order to test the dispensing plant, with the aim of verifying that there are no leaks which might cause infiltrations of the combustible gas into the building. The further inlet 20 has an axis E that is substantially perpendicular to the axes A and B of the inlet 4 and the outlet 3. A connecting element 21 is connected to the further inlet 20, for introducing the test gas, provided with a first seal gasket 18 and a closing element 5, for example a screw cap, for closing the inlet 20 when the inlet is not in use. In certain instances, the first seal gasket 18 serves to guarantee a gas seal between the connecting element 21 and the valve body 2, such that there can be no leakage of gas between the connecting element 21 and the valve body 2.

The valve 1 is destined to be connected to the combustible gas supply network through a gas flow gauge, commonly known as a counter. In other words, the valve 1 is connected with its inlet 4 at the outlet of the counter and with its outlet 3 at the building dispensing plant.

A shutter 11 is arranged internally of the valve 1 body 2, which shutter 11 is constituted by a hollow spherical element provided with a first opening 16 and a second opening 17, also having respective axes C and D which are substantially mutually perpendicular. The first opening 16 and the second opening 17 are destined to enable communication between the inlet 4 and the outlet 3 of the valve body 2, via the shutter 11.

A seating 13 is afforded on the surface of the shutter 11, which seating 13 is destined to couple with an appendage 10 of a maneuvering element 7 provided with a second seal gasket 19 and fixed, via a connecting element 8 and a bolt 9, to a knob 6, by means of which the maneuvering element 7 is activated to command a rotation of the shutter 11. In certain instances, the second seal gasket 19 serves to guarantee a gas seal between the maneuvering element 7 and the valve body 2, such that there can be no leakage of gas between the maneuvering element 7 and the valve body 2.

A third seal gasket 14 and a fourth seal gasket 15 are further associated to the shutter 11, arranged on opposite sides thereof and, in certain instances, destined to guarantee a gas seal between the shutter 11 and the valve body 2, such that there can be no gas leakage between the shutter 11 and the valve body 2.

The shutter 11 is further provided with a third opening 12, destined to place the further inlet 20 of the valve body 2 in communication with the outlet 3, via the shutter 11, in order to enable introduction of pressurized test gas into the plant to be tested. The dimensions of the third opening 12 are much smaller than those of the first opening 16 and the second opening 17 of the shutter 11.

The position and dimensions of the third opening 12 of the shutter 11 are selected such that when the shutter 11 is positioned in a first operating position, such as to place the inlet 4 and the outlet 3 of the valve body 2 in communication, in order to enable supply to the building dispensing plant from the combustible gas supply network, any communication between the inlet 4, the outlet 3 and the further inlet 20 is prevented. In certain instances, this guarantees against the risk that the further inlet 20 can communicate with the supply network or with the building dispensing plant, in the normal functioning of the plant, if, after the testing of the plant, the further inlet 20 is not closed, by mistake, with the screw cap 5, or if the screw cap 5 is removed. In this way the risk of combustible gas infiltrations into the building through the further inlet 20 of the valve body 2 is prevented.

The dimensions and the position of the third opening 12 of the shutter 11 are further chosen such as to enable the shutter 11, in a second operating position, to establish a communication between the further inlet 20 and the outlet 3 of the valve body 2, preventing at the same time there being a communication between the further inlet 20 and the inlet 4 of the valve body 2, or between the inlet 4 and the outlet 3, such as to prevent the pressurized test gas introduced into the valve body 2 from entering the counter and damaging it, or from getting into the supply network and mixing with the combustible gas therefrom. For example, the third opening 12 can have a diameter of about a tenth of the diameter of the first opening 16 and the second opening 17 and an axis F which is coplanar with the axis C of the first opening 16 and inclined by a few degrees, for example between about 5° and about 10°, with respect to the axis C of the first opening 16.

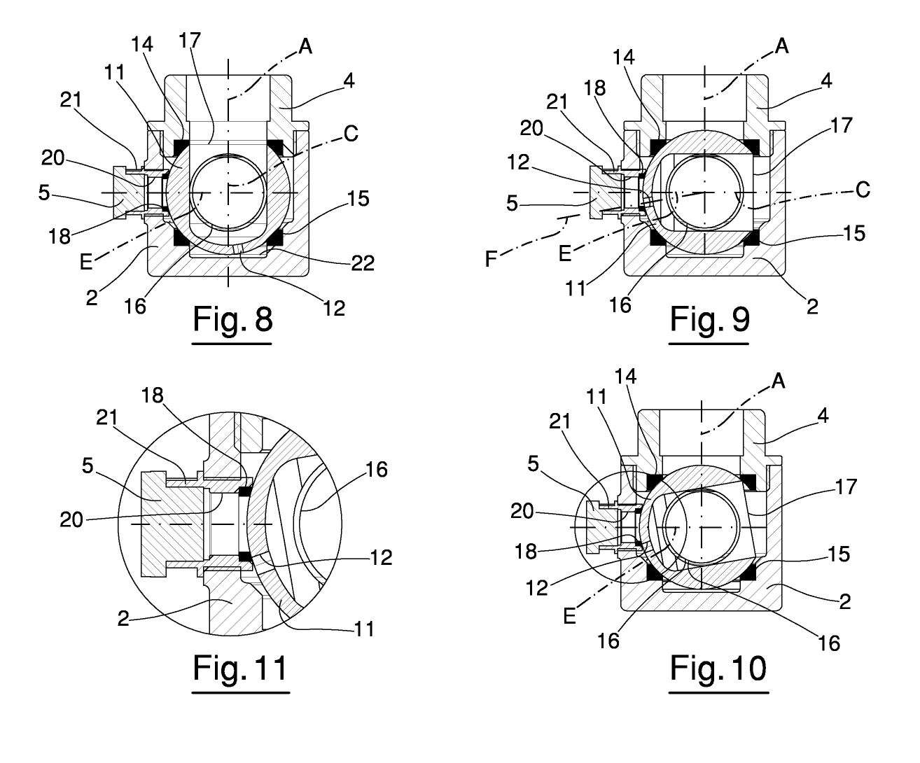

The functioning of the valve 1 is illustrated in FIGS. 8 to 11.

FIG. 8 illustrates the first operating position of the shutter 11, in which the second opening 17 of the shutter 11 communicates with the inlet 4 of the valve body 2, while the first opening 16 communicates with the outlet 3 of the valve body 2, such as to establish a communication between the inlet 4 and the outlet 3, such as to enable combustible gas supply to the building dispensing plant.

The shutter 11 body completely obstructs the further inlet 20 of the valve body 2, while the third opening 12 of the shutter 11 is in a zone of the valve body comprised between a wall 25 of the valve body 2 and the second seal gasket 15, such that outflow of combustible gas is prevented from the further inlet 20 of the valve body 2, even if the closing cap 5 is not applied or removed. This operating position is thus a position of total security, destined to prevent intrusion or accidental escape of combustible gas through the further inlet 20 of the valve body 2 during normal functioning of the combustible gas distribution plant, when the valve 1 is in the open position.

FIG. 9 illustrates the second operating position of the shutter 11, rotated by 90° in the clockwise direction with respect to the first operating position illustrated in FIG. 8. In this second operating position, the first opening 16 of the shutter 11 communicates with the outlet 3 of the valve body 2, the further opening 12 of the shutter 11 communicates with the further inlet 20 of the valve body 2 and the shutter body 11 completely obstructs the inlet 4 of the valve body 2.

This enables introducing a test gas into the building dispensing plant through the further inlet 20 of the valve body 2, the shutter 11 and the outlet 3 of the valve body without the risk that the pressurized test gas can reach the counter connected with the inlet 4 of the valve body 2 and get into the supply network of the combustible gas.

In the second operating position, if the further inlet 20 of the valve body 2 is closed by the cap 5, test gas injection into the building dispensing plant is prevented.

FIGS. 10 and 11 illustrate a third operating position of the shutter 11, which is obtained by rotating the shutter 11 in an anticlockwise direction by some degrees with respect to the position illustrated in FIG. 9. This third position prevents any communication between the inlet 4, the outlet 3 and the further inlet 20 of the valve body 2, such that combustible gas supply to the building dispensing network is prevented, as is any leaking of combustible gas from the further inlet 20 of the valve body 2, even if the closing cap 5 is not applied or is removed.

The third operating position is thus a safety position destined to prevent accidental leakage of combustible gases through the further inlet 20 of the valve body 2, during normal functioning of the combustible gas dispensing plane, when the valve 1 is in the closed position.

The angular distance between the second operating position of the shutter 11, illustrated in FIG. 9, and the third operating position, illustrated in FIGS. 10 and 11, is in the manner of some degrees, for example it is comprised between 5° and 10°, and is particularly about 8°.

In other terms it can readily be understood from the figures that the valve is exclusively configurable between an activated condition (which can be defined by a plurality of relative positions between the valve body and the shutter reciprocally rotated by a few degrees in a clockwise or anticlockwise direction with respect to the condition of FIG. 8), in which the inlet 4 and the outlet 3 of the valve body 2 are set in fluid communication by the first and the second openings of the shutter 11, a test condition (FIG. 9) in which the further inlet 20 and the outlet 3 are set in fluid communication between the first or the second opening (and in more detail, the first) and the third opening 12 of the shutter 11 and a security condition (FIG. 10) in which the shutter is positioned such as to prevent any fluid communication between the inlet 4, the outlet 3 and the further inlet 20 of the valve body 2.

Note that the configurations illustrated in FIGS. 8 to 10 are the only ones possible (even though each of the configurations can comprise various relative angular positions between the valve body and the shutter as long as the respective fluid passage is allowed).

In other words the valve cannot be configured erroneously such that the inlet for the test 20 can communicate with the inlet 4 towards the gas distribution network or the counter.

When passing from the condition of FIG. 10 to the condition of FIG. 8, there is further never a potential communication between all the various openings of the valve body 2.

As soon as a communication channel opens between the inlet 4 and the outlet 3, the test channel is already closed (FIGS. 11, 10 and 8).

In still other terms, the valve enables, whatever the configuration thereof, at most a communication between only two openings 3, 4 and 20, and never a contemporary communication between all three.

In the specific case of the embodiment (which might however take on a different structure as long as the above-described function is maintained) the set aim is attained also thanks to the presence of a seal element 18 between the access 20 and the shutter 11 and the seal element 15 between the valve body 2 and the shutter 11.

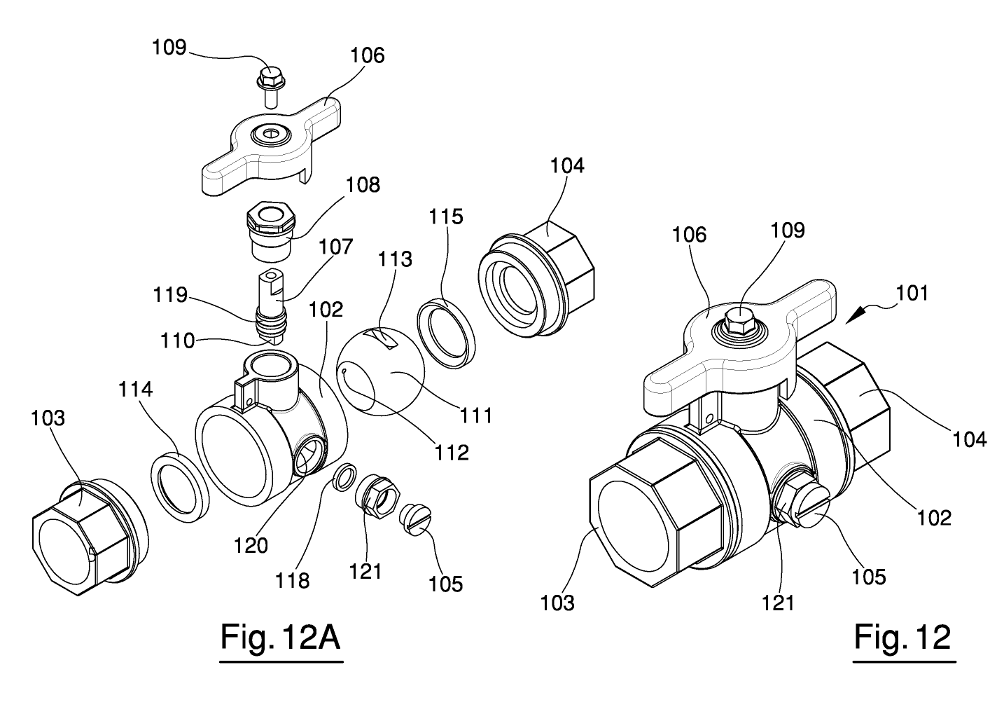

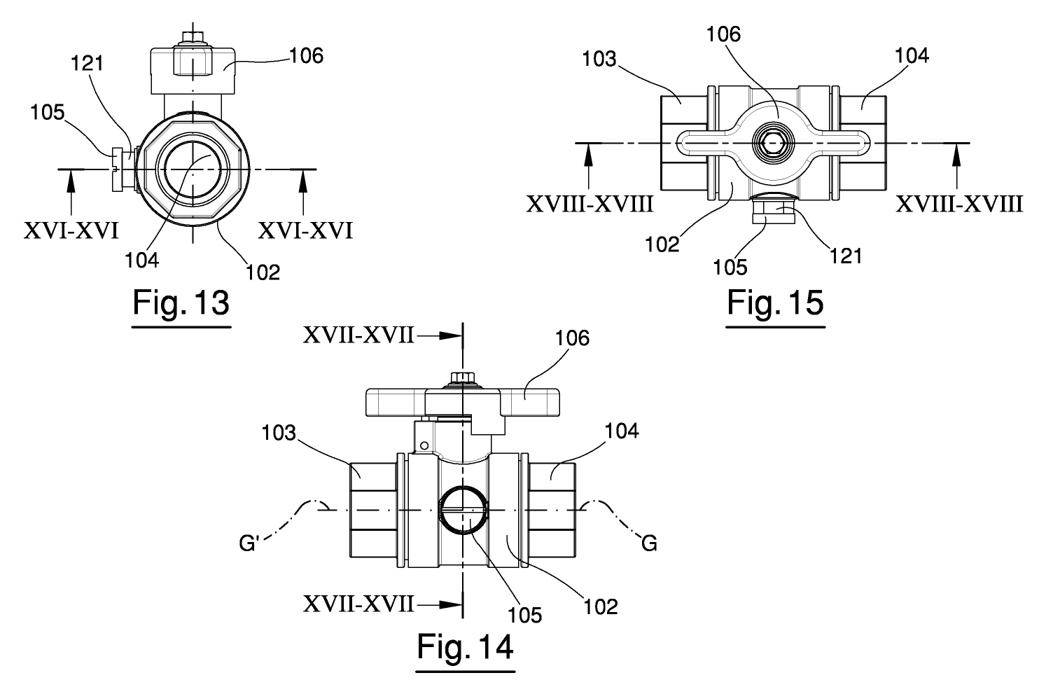

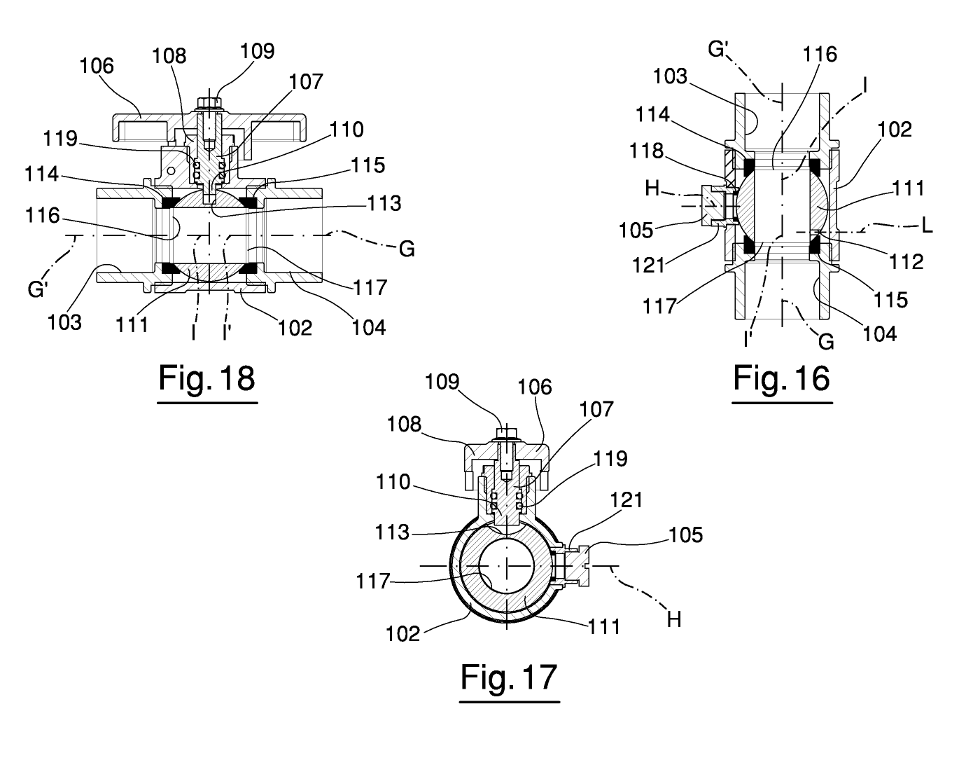

In FIGS. 12 to 22, a second version of the valve 101 in accordance with the concepts described herein is illustrated, which comprises a hollow valve body 102 provided with an inlet 104 destined to be connected to a combustible gas supply network, for example of methane, and an outlet 103 destined to be connected to a dispensing plant of the combustible gas to a building. In the second version, the inlet 104 and the outlet 103 have respective axes G, G′ which are parallel to one another and in detail coincide.

The valve body 102 is further provided with a further inlet 120 usable for introducing a pressurized test gas into the dispensing plant, in order to test the dispensing plant, with the aim of verifying that there are no leaks that might lead to infiltrations of the combustible gas into the building. The further inlet 120 has an axis H which is substantially perpendicular to the respective axes G, G′ of the inlet 104 and the outlet 103. The further inlet 120 is connected to a connecting element 121, for introduction of the test gas, provided with a first seal gasket 118, and a closing element 105, for example a screw cap, for closing the inlet 120 when it is not used. In certain instances, the first seal gasket 118 serves to guarantee a gas seal between the connecting element 121 and the valve body 102, such that gas leakage cannot take place between the connecting element 121 and the valve body 102.

The valve 101 is destined to be connected to the combustible gas supply network through a gas flow gauge, commonly known as a counter. In other words, the valve 101 is connected by the inlet 104 thereof to the outlet of the counter and by the outlet 103 thereof to the building dispensing plant.

A shutter 111 is arranged internally of the valve 101 body 102, which shutter 111 is constituted by a hollow spherical element provided with a first opening 116 and a second opening 117, having respective axes I and I′ which are parallel, and in detail coinciding. The first opening 116 and the second opening 117 are destined to enable communication between the inlet 104 and the outlet 103 of the valve body 102, through the shutter 111.

A seating 113 is afforded on the surface of the shutter 111, which seating 113 is destined to couple with an appendage 110 of a maneuvering element 107 provided with a second seal gasket 119 and fixed, via a connecting element 108 and a bolt 109, to a knob 106, by means of which the maneuvering element 107 is activated to command a rotation of the shutter 111.

In certain instances, the second seal gasket 119 serves to guarantee a gas seal between the maneuvering element 107 and the valve body 102, such that there can be no leakage of gas between the maneuvering element 107 and the valve body 102.

A third seal gasket 114 and a fourth seal gasket 115 are further associated to the shutter 111, arranged on opposite sides of the shutter 111 and, in certain instances, is destined to guarantee a gas seal between the shutter 111 and the valve body 102, such that there can be no gas leakage between the shutter 111 and the valve body 102.

The shutter 111 is further provided with a third opening 112, destined to place the further inlet 120 of the valve body 102 in communication with the outlet 103, via the shutter 111, in order to enable introduction of pressurized test gas into the plant to be tested.

The dimensions of the third opening 112 are much smaller than those of the first opening 116 and the second opening 117 of the shutter 111.

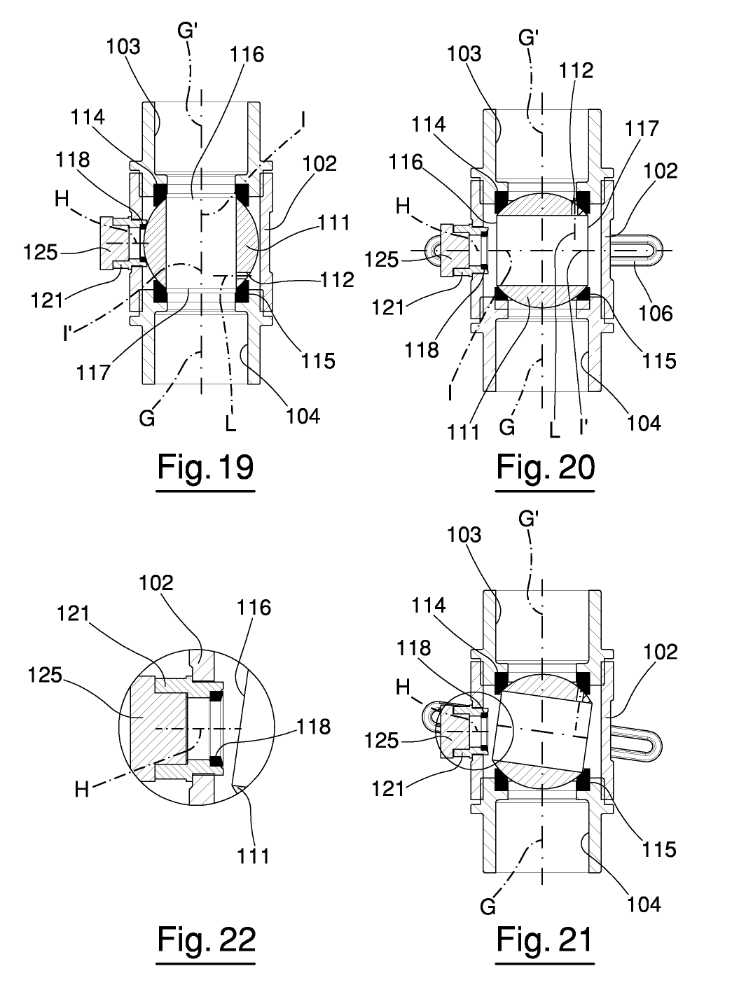

The position and dimensions of the third opening 112 of the shutter 111 are selected such that when the shutter 111 is positioned in a first operating position, such as to place the inlet 104 and the outlet 103 of the valve body 102 in communication, in order to enable supply to the building dispensing plant by the combustible gas supply network, any communication between the inlet 104, the outlet 103 and the further inlet 120 is prevented. In certain instances, this guarantees against the risk that the further inlet 120 can communicate with the supply network or with the building dispensing plant, in the normal functioning of the plant, if, after the testing of the plant, with the shutter 111 in the first operating position (FIG. 19), the further inlet 120 is not closed, by mistake, with the screw cap 5, or if the screw cap 5 is removed. In this way the risk of combustible gas infiltrations into the building through the further inlet 120 of the valve body 102 is prevented.

The dimensions and the position of the third opening 112 of the shutter 111 are further chosen such as to enable the shutter 111, in a second operating position, to establish a communication between the further inlet 120 and the outlet 103 of the valve body 102, preventing at the same time there being a communication between the further inlet 120 and the inlet 104 of the valve body 102, or between the inlet 104 and the outlet 103, such as to prevent the pressurized test gas from being introduced into the valve body 102 and damaging it, or from getting into the supply network and mixing with the combustible gas therefrom. For example, the third opening 112 can have a diameter of about a tenth of the diameter of the first opening 116 and the second opening 117 and an axis L which is substantially perpendicular to the respective axes I, I′ of the first opening 116 and the second opening 117. Further, the axis L of the third opening 112 is positioned at a distance of about half the radius of the shutter 111 with respect to a plane of symmetry of the shutter 111 that is perpendicular to the respective axes I, I′ of the first opening 116 and the second opening 117.

The functioning of the valve 101 is illustrated in FIGS. 19 to 22.

FIG. 19 illustrates the first operating position of the shutter 111, in which the second opening 117 of the shutter 111 communicates with the inlet 104 of the valve body 102, while the first opening 116 communicates with the outlet 103 of the valve body 102, such as to establish a communication between the inlet 104 and the outlet 103, such as to enable combustible gas supply to the building dispensing plant.

The shutter 111 body completely obstructs the further inlet 120 of the valve body 102, while the third opening 112 of the shutter 111 is in a zone of the valve body comprised between the third seal gasket 114 and the fourth seal gasket 115, such that outflow of combustible gas passing through the valve body 102 cannot reach the further inlet 120 and exit therefrom.

Thus leakage of combustible gas from the further inlet 120 of the valve body 2 is prevented, even if the closing cap 105 is not applied or is removed.

This operating position is thus a position of total security, destined to prevent intrusion or accidental escape of combustible gas through the further inlet 120 of the valve body 102 during normal functioning of the combustible gas distribution plant, when the valve 1 is in the open position.

FIG. 20 illustrates the second operating position of the shutter 111, rotated by 90° in the anticlockwise direction with respect to the first operating position illustrated in FIG. 19. In this second operating position, the first opening 116 of the shutter 111 communicates with the further inlet 120 of the valve body 102, the further opening 112 of the shutter 111 communicates with the outlet 103 of the valve body 102 and the body of the shutter 111 completely obstructs the inlet 104 of the valve body 102.

This enables introduction of a test gas into the building dispensing plant through the further inlet 120 of the valve body 102, the shutter 111 and the outlet 103 of the valve body without the risk that the pressurized test gas can reach the counter connected with the inlet 104 of the valve body 102 and get into the supply network of the combustible gas.

In the second operating position, if the further inlet 120 of the valve body 102 is closed by the cap 105, test gas injection into the building dispensing plant is prevented.

FIGS. 21 and 22 illustrate a third operating position of the shutter 111, which is obtained by rotating the shutter 111 in a clockwise direction by some degrees with respect to the position illustrated in FIG. 20. This third operating position prevents any communication between the inlet 104, the outlet 103 and the further inlet 120 of the valve body 102, such that combustible gas supply to the building dispensing network is prevented, as is any leaking of combustible gas from the further inlet 120 of the valve body 102, even if the closing cap 105 is not applied or is removed.

The third operating position is thus a security position destined to prevent accidental leakage of combustible gases through the further inlet 120 of the valve body 102, during normal functioning of the combustible gas dispensing plane, when the valve 101 is in the closed position.

The angular distance between the second operating position of the shutter 111, illustrated in FIG. 20, and the third operating position, illustrated in FIGS. 21 and 22, is in the manner of some degrees, for example it is comprised between 5° and 10°, and is in detail about 8°.

In this embodiment too, as in the preceding one, the channels and the openings of the shutter can be so dimensioned, as can their geometry and position, the respective sealing element and the valve body, as to prevent any contemporary fluid communication between more than two of the inlets 104, 120 and the outlet 103. It is also possible to prevent communication between the inlet for the test and the counter/gas network, preventing the drawbacks described in the prior art.

The above is also (though not necessarily) due to the particular offset position of the test channel 112 of the shutter (see FIGS. 19-21).

By positioning the channel 112 laterally and opportunely arranging the seal gaskets, the predetermined security objectives can be more simply achieved.

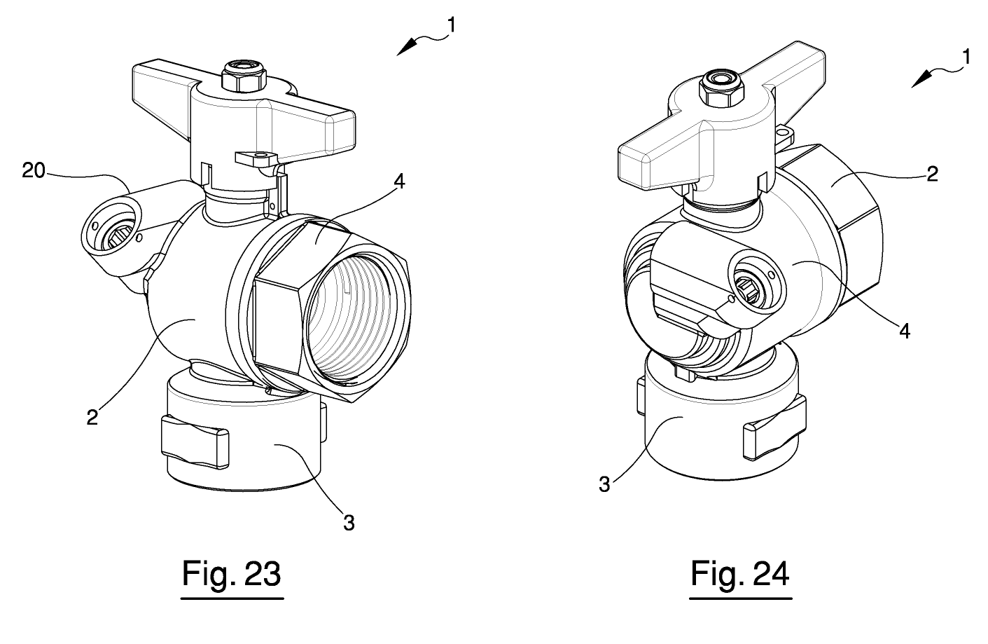

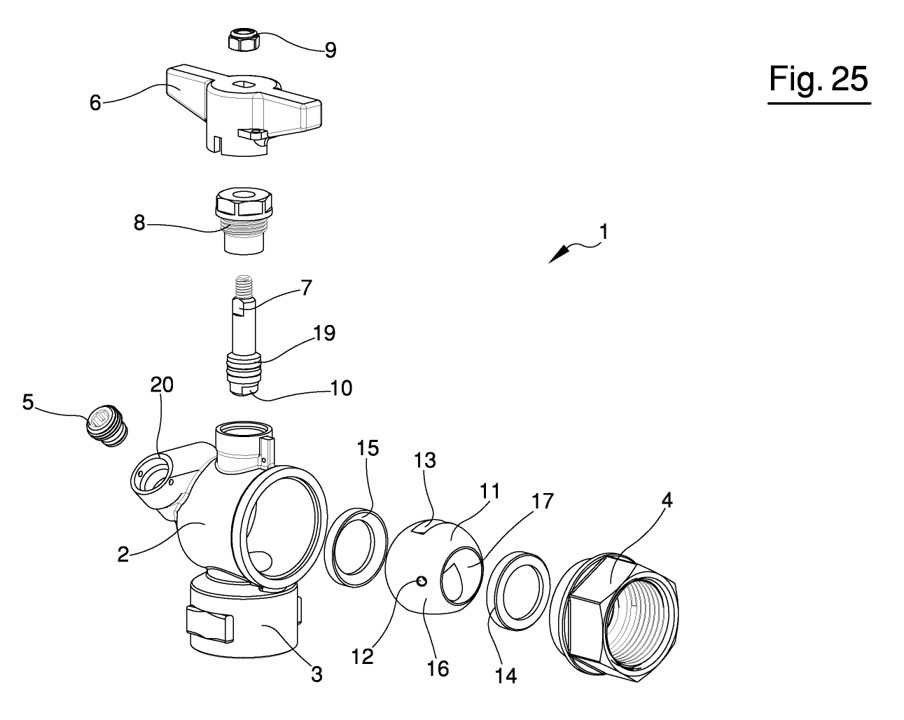

FIGS. 23 to 28 illustrate a third version of a valve 1 in accordance with the concepts described herein. As can be observed, the embodiment substantially coincides with the first embodiment (FIGS. 1-11) and for this reason the same numerical references have been used to indicate corresponding parts (or identical parts).

There are only a few small constructional differences, connected for example to the test channel which is conformed in the special manner illustrated in FIG. 23, making the connection and the verification operations easier inasmuch as the channel is both inclined and more external with respect to the valve body (as well as being of a piece there-with).

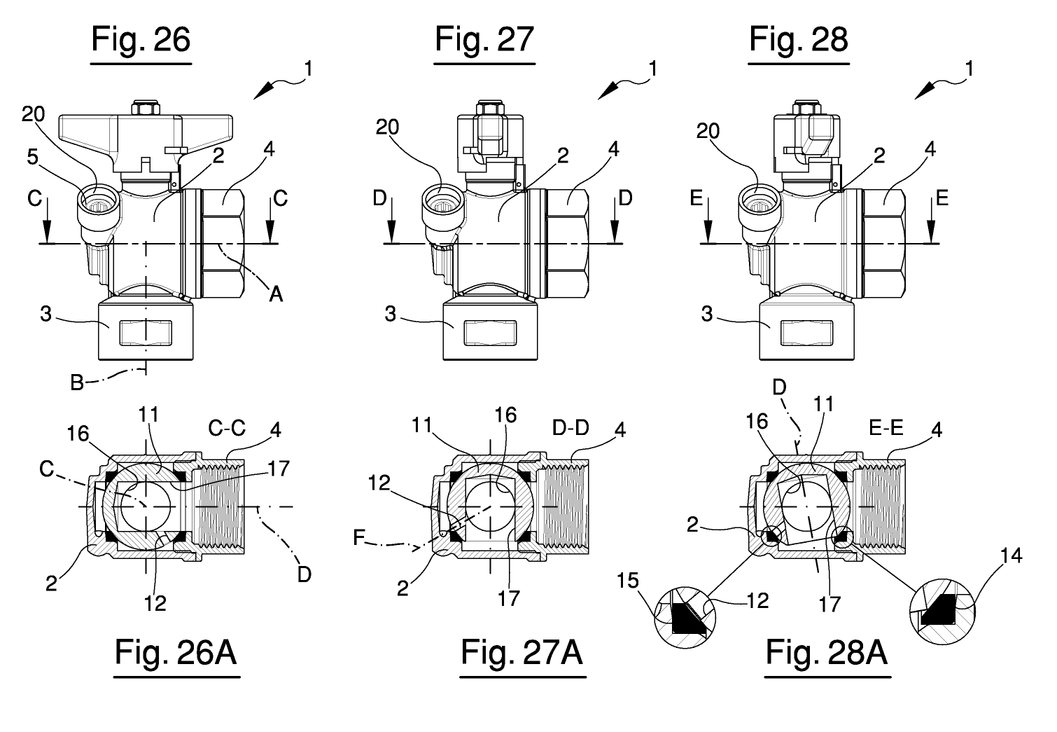

By inclining the axis F more significantly with respect to the axis C, in the movement from the closed condition (FIG. 27) towards the open condition (in sequence FIG. 28 and FIG. 26), the test conduit 12 is immediately intercepted by the seal 15, preventing possible fluid communication between the test conduit and the gas supply.

Note that the positions of FIGS. 26, 27 and 28 coincide with those of FIGS. 8, 9 and 10 respectively.

In the practical actuation, the materials, dimensions and carrying-out details can be different from those indicated, but will be technically-equivalent thereto.

What is claimed is:

1. Shut off and test valve for gas plants comprising a base body having an inlet for entry of a fluid into the base body, an outlet for exit of the fluid from the base body and a further test inlet, a hollow shutter having a first opening, a second opening and a third opening in fluid communication with each other inside the shutter itself, the valve being exclusively configurable between a use condition in which the inlet and the outlet of the base body are in fluid communication through the first and the second openings of the shutter, a test condition in which the further inlet and the outlet are placed in fluid communication through the first or the second opening and the third opening of the shutter and a security condition in which the shutter is positioned so that any fluid communication is prevented between said inlet, outlet and further inlet of the base body.

2. Valve according to claim 1, wherein the hollow shutter is spherical.

3. Valve according to claim 1, wherein said third opening exhibits smaller dimensions than dimensions of the second opening.

4. Valve according to claim 3, wherein said third opening has a diameter equal to about one tenth of the diameter of said first opening and of the second opening.

5. Valve according to claim 1, wherein said first opening has a diameter equal to the diameter of the second opening.

6. Valve according to claim 1, wherein the use condition and the security condition each comprise a plurality of relative positions between the base body and the shutter.

7. Valve according to claim 1, wherein said inlet and outlet have substantially orthogonal respective axes.

8. Valve according to claim 7, wherein said further inlet has an axis that is substantially orthogonal to the respective axis of said inlet and outlet.

9. Valve according to claim 8, wherein said first opening and second opening have substantially orthogonal respective axis.

10. Valve according to claim 9, wherein said third opening has an axis that is coplanar with the axis of the second opening, the axis of said third opening having an inclination comprised between about 5° and about 10°, with respect to axis of said second opening.

11. Valve according to claim 1, wherein said inlet and said outlet have respectively parallel axis, said further inlet having an axis that is substantially orthogonal to the respective axis of said inlet and said outlet.

12. Valve according to claim 11, wherein said inlet and said outlet have respectively coincident axes.

13. Valve according to claim 12, wherein said first opening and said second opening have substantially parallel respective axes, said third opening having an axis that is substantially orthogonal to the respective axis of said first opening and of said second opening.

14. Valve according to claim 13, wherein the axis of said third opening is positioned at a distance of about a half of a radius of the shutter with respect to a plane of symmetry of the shutter that is perpendicular to the respective axis of said first opening and of said second opening.

15. Valve according to claim 1, wherein said shutter is movable through a manoeuvring element connected to a knob and comprises an appendage destined to engage in a seating of said shutter.

16. Valve according to claim 1, wherein a connecting element is associated to said further inlet, first sealing element being associated to said connection element, which sealing element is destined to define a gas seal between said connection element and said base body.

17. Valve according to claim 16, wherein said connection element further comprises a closure element of said further inlet, second sealing element being associated to said manoeuvring element, said second sealing element being destined to define a gas seal between said manoeuvring element and said base body.

18. Valve according to claim 17, wherein third sealing element and fourth sealing element are associated to said shutter, said third and fourth sealing elements being destined to define a gas seal between said shutter and said valve body, said third sealing element and said fourth sealing element being located in opposite positions with respect to said shutter.

19. Shut off and test valve for gas plants comprising a base body having an inlet for entry of a fluid into the base body, an outlet for exit of the fluid from the base body and a further test inlet, a hollow shutter having a first opening, a second opening and a third opening in fluid communication with each other inside the shutter itself, the valve being configurable between a use condition in which the inlet and the outlet of the base body are in fluid communication through the first and the second openings of the shutter, a test condition in which the further inlet and the outlet are placed in fluid communication through the first or the second opening and the third opening of the shutter and a security condition in which the shutter is positioned so that any fluid communication is prevented between said inlet, outlet and further inlet of the base body.

20. Shut off and test valve for gas plants comprising a valve body, having an inlet for fluid entrance into the valve body, an outlet for exit of the fluid from the valve body and a further test inlet, a hollow shutter having a first opening a second opening and a third opening in fluid communication with each other inside the shutter itself, the valve being configurable between a use condition in which the inlet and the outlet of the valve body are placed in fluid communication through the first and the second openings of the shutter, a test condition in which said further inlet and the outlet are in fluid communication though the first or the second opening and the third opening of the shutter and a security condition in which the shutter is positioned such as to prevent any fluid communication between said inlet, outlet and further inlet of the valve body, said first opening and said second opening having respective substantially parallel axes, said third opening having an axis substantially orthogonal to a respective axis of said first opening and of said second opening the axis of said third opening being positioned at a distance of about one half a radius of the shutter with respect to a plane of symmetry of the shutter which is orthogonal to the respective axis of said first opening and of said second opening.
